(19) United States
(12) Patent Application Publication
(10) Pub. No.: US 2012/0151592 A1
(43) Pub. Date: Jun. 14, 2012

(54) STRING OPERATIONS WITH TRANSDUCERS

(75) Inventors: Margus Veanes, Bellevue, WA (US); Pieter Hooimeijer, Charlottesville, VA (US); Benjamin Livshits, Kirkland, WA (US); Prateek Saxena, Berkeley, CA (US); David Molnar, Berkeley, CA (US)

(73) Assignee: MICROSOFT CORPORATION, Redmond, WA (US)

(21) Appl. No.: 12/965,930

(22) Filed: Dec. 13, 2010

(51) Int. Cl. G06F 11/00

(52) U.S. Cl. 726/25

(57) ABSTRACT

There is provided a computer-implemented method for analyzing string-manipulating programs. An exemplary method comprises describing a string-manipulating program as a finite state transducer. The finite state transducer may be evaluated with a constraint solving methodology to determine whether a particular string may be provided as output by the string-manipulating program. The constraint solving methodology may involve the use of one or more satisfiability modulo theories (SMT) solvers. A determination may be made regarding whether the string-manipulating program may contain a potential security risk depending on whether the particular string may be provided as output by the string-manipulating program.

### BACKGROUND

A large fraction of security vulnerabilities arise due to errors in string-manipulating code. Developers frequently use low-level string operations, like concatenation and substitution, to manipulate data that follows a particular high-level structure, like HTML or SQL. This leads to problems if the code fails to adhere to that intended structure, causing the output to have unintended consequences. The growing rate of security vulnerabilities, for example, in web applications, has sparked interest in techniques for vulnerability discovery in existing applications.

Cross-site scripting (“XSS”) attacks are an example illustrative of the problem. These attacks happen because the applications take data from untrusted users, then echo this data to other users of the application. Because web pages mix markup and JavaScript, this data may be interpreted as code by a browser, leading to arbitrary code execution with the privileges of the victim. The first line of defense against XSS attacks is the practice of sanitization, where untrusted data is passed through a string-manipulation program known as a sanitizer, a function that escapes or removes potentially dangerous strings.

For example, a web application may apply a sanitization function to a string sent by a user of the application to ensure that the string is not interpreted as JavaScript code. Many different sanitization functions exist for different contexts, and there are even multiple different implementations of the same sanitizer. Unfortunately, determining whether any existing sanitizer effectively protects a computer program is challenging.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a system and method for evaluating string-manipulating programs. An exemplary method comprises describing a string-manipulating program using a finite state transducer such as a symbolic finite state transducer. The operation of the string-manipulating program, as represented by the finite state transducer, may be analyzed with a constraint solving methodology to determine whether a particular string may be provided as an output of the string-manipulating program. The constraint solving methodology may involve the use of one or more SMT solvers. A determination may be made regarding whether the particular string, if provided as output of the string-manipulating program, corresponds to a potential security risk. If the string represents a potential security risk, a sanitization function may be performed on the string to obviate the potential security risk. Potential security risks that may be addressed include XSS attacks and SQL injection.

An exemplary system for identifying potential security risks comprises a processing unit and a system memory. The system memory stores code configured to direct the processing unit to describe a string-manipulating program using a finite state transducer. Also stored in the system memory is code configured to direct the processing unit to analyze the finite state transducer with a constraint solving methodology to determine whether a particular string is a possible output of the string-manipulating program. Code is additionally stored in the system memory configured to cause the processing unit to determine whether the string-manipulating program may contain a potential security risk depending on whether the particular string may be provided as output by the string-manipulating program.

An exemplary embodiment of the subject innovation relates to one or more computer-readable storage media. The one or more computer-readable storage media store code configured to direct a processing unit to describe a string-manipulating program using a finite state transducer. The one or more computer-readable storage media also stores code configured to direct the processing unit to analyze the finite state transducer with a constraint solving methodology to determine whether a particular string may be provided as output by the string-manipulating program. Code is also stored on the one or more computer-readable storage media that is configured to direct the processing unit to determine whether the string-manipulating program may contain a potential security risk depending on whether the particular string may be provided as output by the string-manipulating program.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a system for sanitizing untrusted code in accordance with the subject innovation;

FIG. 2 is a diagram showing a plurality of finite state transducers according to the subject innovation;

FIG. 3 is a state diagram showing a finite state transducer for a slide function according to the subject innovation;

FIG. 4 is a block diagram showing a finite state transducer realizing a prefix operation according to the subject innovation;

FIG. 5 is a block diagram showing a transducer according to the subject innovation;

FIG. 6 is a block diagram showing transducers according to the subject innovation

FIG. 7 is a process flow diagram of a method for evaluating string-manipulating programs in accordance with the subject innovation;

FIG. 8 is a block diagram of an exemplary networking environment wherein aspects of the claimed subject matter can be employed; and

FIG. 9 is a block diagram of an exemplary operating environment that can be employed in accordance with the subject innovation.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “server,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

1. Introduction

The subject innovation relates to modeling imperative string operations with transducers, such as finite state transducers. In general, a transducer is a way of writing a method for transforming an input string into an output string. A transducer includes a set of “states.” A single state is distinguished as the “input state”, while another set of states are distinguished as “final states.” When transforming an input string, the transducer marks the input state as “active.” Each state has an associated set of “transitions” that embody several characteristics. One characteristic is the identity of a character of the input is present for the transition to occur. Another characteristic is the set of characters that should be output by the transducer. Still another characteristic is the new state that should be marked as “active.” The transducer reads a first character of a current input string, then matches the character against the list of transitions in the state marked as active. If no transitions match, or if the current state is one of the “final states,” the transducer halts and the transformation is complete.

In an exemplary embodiment, finite state transducers are generalized with logical formulas in each transition instead of specific characters. This generalization is called a symbolic finite state transducer or SFT. The SFT may be analyzed to determine whether corresponding strings, if produced by a computer program, could contribute to a potential security risk by enabling an adversary to change desired behavior of an executing program by manipulation of the string output. Modeling sets of strings as logical formulas may be used to address potential security risks such as cross-site scripting or SQL injection. In addition, modeling string manipulating functions as symbolic finite transducers provides a way to compare computer program implementations of string-manipulating programs such as sanitizers against each other and to compare against specifications of data that trigger unwanted behavior. Sanitizers are computer programs that provide sanitization functions, such as disabling execution of code that represents a potential security risk. For example, a sanitizer may remove all occurrences of the string “<SCRIPT>” from an input, because web browsers that read the string “<SCRIPT>” will treat what follows as JavaScript code.

An analysis of symbols corresponding to strings with constraint solving tools allows identification of strings that, if produced as an output of a computer program, could pose a potential security risk by improving chances of an adversary to perform malicious acts. Moreover, an exemplary embodiment may facilitate efficient comparisons of existing sanitizers against each other or against new implementations.

In one exemplary embodiment, constraint solving tools known as satisfiability modulo theories (SMT) solvers are employed to evaluate symbols describing strings. In general, SMT solvers determine whether a given relationship is satisfiable. In the context of the subject innovation, symbolic finite transducers have logical formulas on each transition. An SMT solver can find strings that satisfy these formulas and will cause such a transition to occur.

A combination of SMT solvers and finite state transducers provides a methodology for reasoning precisely about the sanitization functions used for enforcing security guarantees. An exemplary embodiment facilitates improvement in the ability of SMT solvers to reason about string constraints.

A domain-specific language may be used for writing sanitization functions according to the subject innovation. In general, a domain-specific programming language is a programming language with restricted vocabulary and special constructions that make it appropriate for a specific application. For example, the LOGO language commonly used to teach programming to young children has a special notion of a drawing device that can be moved using direct commands in the language. A domain-specific language according to the subject innovation is desirably expressive enough to capture a large class of sanitization functions in use.

Questions about behavior of functions can be translated into questions concerning a new class of symbolic finite state machines. These questions can be answered using automatic theorem proving. A domain-specific language according to the subject innovation may be designed specifically to capture the class of programs used to implement sanitization functions yet still make answering questions about the behavior of programs tractable. The translation from questions about program behavior to symbolic finite state machines facilitates improved performance when answering these questions.

A domain-specific imperative language according to the subject innovation directly models low-level string manipulation code featuring boolean state, search operations, and substring substitutions. Such a language may be reversible through a semantics-preserving translation to symbolic finite state transducers. An exemplary embodiment of the subject innovation takes advantage of the fact that many security-related string functions can be modeled precisely using finite state transducers over a symbolic alphabet. Symbolic finite state transducers annotate transitions with logical formulae. Moreover, symbolic finite state transducers provide a methodology to integrate classic theory of finite state transducers with the developments relating to SMT solvers. An efficient encoding from symbolic finite state transducers into the higher-order theory of algebraic datatypes may be realized. The practical utility of a program language according to the subject innovation as a constraint language in the domain of web application sanitization code may be shown. Exemplary embodiments of the subject innovation may be useful in addressing real-world queries regarding, for example, the idempotence and relative strictness of popular sanitization functions.

An exemplary domain-specific language for writing sanitazation functions according to the subject innovation is referred to herein by the name “Bek.” The Bek language may be used for modeling string transformations. The language is intended to be (a) sufficiently expressive to model real-world code, and (b) sufficiently restricted to allow precise analysis using transducers. Bek can model real-world sanitization functions, such as those in the .NET System.Web library, without approximation. A translation from Bek expressions to the theory of algebraic datatypes is provided, allowing Bek expressions to be used directly when specifying constraints for an SMT solver, in combination with other theories. The analysis of Bek expressions is facilitated by a theory of symbolic finite state transducers, an extension of standard form finite state transducers that is described herein.

In addition, a theory of symbolic transducers is introduced, showing its integration with other theories in SMT solvers that support E-matching. A tractable encoding of symbolic finite state transducers into the theory of algebraic data types is set forth. With respect to the encoding, given sufficient resources, any given query yields a finite-length proof. The concept of join composition enables the preservation of a desirable property of reversibility (i.e, given an output, produce corresponding inputs) that facilitates the checking sanitizer correctness.

A translation of Bek expressions into symbolic finite state transducers is provided. For purposes of evaluation, it may be shown that known sanitization procedures can be ported to Bek with little effort. Each such port matches the behavior of the original procedure without conservative over-approximation. Exemplary embodiments may generate witnesses for known vulnerabilities. The subject innovation may facilitate resolving queries that are of practical interest to both users and developers of sanitization routines, such as “do two sanitizers exhibit deviant behaviors on certain inputs,” “do multiple applications of a sanitizer introduce errors,” or “given a possibility of attack output, what is the maximal set of corresponding inputs that demonstrate the attack?” As set forth herein, the subject innovation relates to a domain-specific language for string manipulation. A syntax-driven translation from expressions in the domain-specific language to symbolic finite state transducers is described.

Symbolic finite state transducers and their reduction to the theory of algebraic datatypes is set forth herein, including the intersection and composition operations. In addition, it is shown that an exemplary domain-specific language such as Bek can encode real-world string manipulating code used to sanitize untrusted inputs in Web applications.

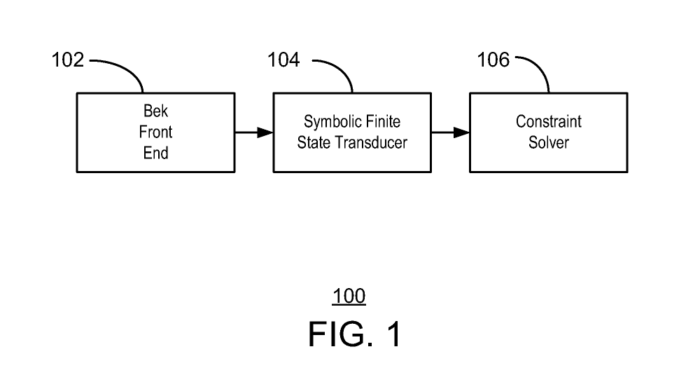

FIG. 1 is a block diagram of a system 100 for sanitizing untrusted code in accordance with the subject innovation. Moreover, the system 100 provides a way to evaluate string-manipulating programs to determine if a potential output of the string-manipulating program may comprise a security risk. If so, a sanitization procedure may be performed to obviate the potential risk. The system 100 has a front end 102 based on a domain-specific language for writing sanitization functions according to the subject innovation. Moreover, the front end 102 may describe strings of interest as symbols using finite state transducers. The front end 102 is coupled to a symbolic finite state transducer 104, which is in turn coupled to a constraint solver 106.

The symbolic finite state transducer 104 may employ a symbolic finite state machine that represents a particular function from strings to strings. In general, a finite state transducer is a way of writing down functions from strings to strings. A finite state transducer may be made to be “symbolic” by designing the transitions in the finite state machine to have logical formulas or constraints over strings, not just specific characters. For example, a transition in a finite state machine may say “If the character is an ‘A’, output ‘b’ and transition to state 2.” A symbolic finite state machine, may perform the following: “If the character is uppercase OR ‘b’, output ‘a’ and transition to state 2.”

The constraint solver 106 may employ constraint-solving methods, including the use of one or more SMT solvers, to analyze symbols corresponding to strings. As described herein, the analysis of symbols may provide a basis for identifying a potential security risk if strings corresponding to a symbol are produced as output by a computer program. In particular, a string output may be known to result in a security vulnerability that may be exploited by an adversary. An exemplary embodiment may be used to identify whether a computer program may produce this undesirable output unexpectedly.

2 Motivating Example

The subject innovation is discussed herein in context using a code fragment from version 2.6.0 of wu-ftpd, a file transfer server, written in C, that has a known format string vulnerability. The code segment is set forth below:

| | |
|---|---|
| void site_exec(char *cmd) | |
| { | |
| char buf[MAXPATHLEN], *slash, *t; | |
| /* sanitize the command string */ | |
| char *sp = (char*) strchr(cmd, ‘ ’); | 5 |
| if (sp == 0) { | |

while((slash = strchr(cmd, ‘/’)) != 0)

| | |
|---|---|
| cmd = slash + 1; | |
| } | |
| else { | 10 |
| while(sp && | |
| (slash = (char*) strchr(cmd, ‘/’)) && | |
| (slash < sp)) | |
| cmd = slash + 1; | |
| } | 15 |
| for (t = cmd; *t !isspace(*t); t++) | |
| if (isupper(*t)) *t = tolower(*t); | |
| /* build the command */ | |
| int pathlen = strlen(PATH); | |
| int cmdlen = strlen(cmd); | 20 |
| if (pathlen + cmdlen +2 > sizeof (buf)) | |
| return; | |
| sprintf(buf, ‘’%s/%s, PATH, cmd); | |
| /* ... execute buf, store results ... */ | |
| fprintf(remote_socket, cmd); | 25 |
| } | |

The source code example uses hand-written sanitization and checks to avoid a buffer overrun (successfully, line 21) and a format string vulnerability (unsuccessfully, line 25). Also, the code example, serves to enforce path-related policies (successfully).

The SITE EXEC portion of the file transfer protocol allows remote users to execute certain commands on the local server. The cmd string holds untrusted data provided by such a remote user; an example benign value is “/usr/bin/ls-1*.c”. This code is an indicative example of realistic string processing. It tries to accomplish several tasks at once, and it relies on character-level imperative updates to manipulate its input. Control flow depends on string values.

The variable PATH points to a directory containing executable files that remote users are allowed to invoke (e.g., “/home/ftp/bin”). To prevent the remote user from invoking other executables via pathname trickery (e.g., cmd==“../../../bin/dangerous”), lines 5-15 of the example code sanitize the command string by skipping past all slash-delimited path elements. However, skipping past all slashes does not have the desired effect: “/bin/echo ‘10/5=2”’ should become “/echo ‘10/5=2”’ and not “5=2′”. Moreover, slashes should only be removed from the command, not from the arguments. The strchr invocation on line 5 is used to check if any spaces are present (line 6). If so, a more complicated version of the slash-skipping logic is used (lines 10-15) that only advances cmd past slashes before the first space. Lines 18-22 build the command that will be executed (e.g., completing the transformation from “/usr/bin/ls-1 *.c” to “/home/ftp/bin/ls-1 *.c”) by using sprintf to concatenate the trusted directory, a slash, and the suffix of the user command. The check on line 21 prevents a buffer overrun on the local stack-allocated variable buf by explicitly adding together the two string lengths, one byte for the slash, and one byte for C's null termination, and comparing the result against the size of buf.

More tellingly, while the code correctly avoids buffers overruns and implements its path-based security policy, it is vulnerable to a format string attack. Since the user's command is passed as the format string to fprintf (line 25), if it contains sequences such as % d or % s they will be interpreted by printf's formatting logic. This typically results in random output, but careful use of the uncommon % n directive, which instructs printf to store the number of characters written so far through an integer pointer on the stack, can allow an adversary to take control of the system. One example of just such an attack against this code was made publicly available.

3 Modeling Low-Level String Operations

This section provides a high-level description of an exemplary small imperative language (herein referred to as Bek) of low-level string operations. In an exemplary embodiment, it is desirably possible to model Bek expressions in a way that allows for their analysis using existing constraint solvers. Second, Bek is desired to be sufficiently expressive to closely model real-world code (such as the wu-ftpd example of example). Moreover, this section presents forward operational semantics for an exemplary programming language, and provides examples. In the sections that follow, it is demonstrated that a programming language according to an exemplary embodiment can be integrated into existing constraint solvers.

An exemplary sytax for Bek is set forth below in Table 1:

TABLE 1
Exemplary Syntax for Domain-Specific Programming Language Bek

| | | | | |
|---|---|---|---|---|
| BoolConstants | B | ∈ {T, F} | BoolVariables | b, . . . |
| CharConstants | d | ∈ Σ | CharVariables | c, . . . |
| IntConstants | n | ∈ [symbol] | StringVariables | t |

| | | | |
|---|---|---|---|
| StringLiterals | const | ∈ Σ* | |
| Expressions | strexpr | :: = | iter[cseq in strexpr](init) {clist} |
| | | \| | (strexpr)fromposexpr |
| | | \| | (strexpr)uptoposexpr |
| | | \| | strexpr · const \| const · strexpr |
| | | \| | t |
| | cseq | :: = | c \| c,cseq |
| | init | :: = | b: = B,init \| ε |
| | clist | :: = | case clist \| case |
| | case | :: = | case(bexpr) {cstmt} |
| | cstmt | :: = | cstmtcstmt \| pass; |
| | | \| | b: = boolexpr; |
| | | \| | yield(chexpr); |
| Positions | posexpr | :: = | pterm |
| | | \| | (pterm) ⋄ n ⋄ ∈ {+,−} |
| | pterm | :: = | lastconst |
| | | \| | firstconst |
| Booleans | bexpr | :: = | bexpr v bexpr \| bexpr [symbol] bexpr |
| | | \| | [symbol] (bexpr) \| chexpr = chexpr |
| | | \| | bexpr = bexpr \| B \| b |
| Characters | chexpr | :: = | c \| d \| $ |

According to the subject innovation, well-formed Bek expressions are functions of the following type: string->string. The language provides basic constructs to filter and transform the single input string.

A single string variable, t, may be defined to represent an input string, and a number of expressions that can take either t or another expression as their input. The from and upto constructs represent search operations that truncate their input starting at (or ending with) the occurrence of a constant search string. Without the integer argument, the results of both and include the matched search constant.

### EXAMPLE 1

The following expression searches for the last occurrence of foo in its input, returning everything following the match (if any).

(t) from (lastfoo)−1;

If applied to the string foofoo, the output would be ofoo. If last is replaced with first, the result would also be ofoo, since there is no earlier occurrence of foo that has one preceeding character in the string.

The iter construct is designed to model loops that traverse strings while making imperative updates. Given a string expression (strexpr), a sequence of character binders (cseq), and an optional initial boolean state (init), an iter- block provides a sliding window over its input. For the ith (0-based) iteration, the character binders c₁,. . . cₙ are bound to characters w, through wᵢ₊ₙ₋₁ in the input. If some wⱼ do not exist (i.e., the end of the input has been reached), then the corresponding character binder is assigned the symbol $. The case statements inside the block can yield zero or more characters, and update the boolean state (affecting future iterations).

### EXAMPLE 2

The following expression represents a basic sanitizer that escapes single and double quotes (but only if they are not escaped already). An iter block declares a single-character window (c₁) and a single boolean state variable b₁, which is initially false. An exemplary iter block is set forth below:

$$iter [ {c}_{1} in t ] ( {b}_{1} = F ) \{ \\ case ( ( {b}_{1} ) ( {c}_{1} = {}^{′} {c}_{1} = {}^{″} ) ) \{ \\ {b}_{1} := F ; yield ( \backslash ) ; yield ( {c}_{1} ) ; \\ \} case ( {c}_{1} = \backslash ) \{ \\ {b}_{1} := ( {b}_{1} ) ; yield ( {c}_{1} ) ; \\ \} case ( T ) \{ {b}_{1} := F ; yield ( {c}_{1} ) ; \\ \} \\ \}$$

The boolean variable b₁ is used to track whether the previous character seen was an unescaped slash. For example, in the input \\” the double quote is not considered escaped, and the transformed output is \\\”. If the expression is applied to \\\” again, the output is the same. It may be desirable to know whether this holds for any output string. In other words, it may be desirable to know whether a function that creates a given Bek expression is idempotent. A function is idempotent if applying the function two or more times in succession to an input has the same effect as applying the function only once. In the context of the subject innovation, idempotence is a desirable property for sanitizers, because if a sanitizer is idempotent then it means developers do not need to concern themselves whether a sanitizer has been applied more than once.

If implemented wrongly, double applications of such sanitization functions have resulted in duplicate escaping, which could potentially open real systems to command injection of script-injection attacks. Checking idempotence of certain functions using symbolic finite transducers is practically useful. The transducer translation presented in Section 4 can be used to prove such properties about expressions including idempotence, reversibility and commutation according to an exemplary programming language such as Bek. Moreover, it may be desirable to determine whether a symbolic finite transducer according to the subject innovation is idempotent, reversible or whether two symbolic finite state transducers commute. It may be desirable to determine if two finite state transducers are equivalent, if one finite state transducer is a subset of another, or to determine the set of strings output by two transducers. These properties may have implications regarding whether certain outputs of a string-manipulating program may be subject to specific types of security vulnerabilities.

Table 2 shows selected operational semantics for a construct, which provides a sliding window over the value of a string expression:

TABLE 2
Selected Operational Semantics
$\frac{\begin{matrix}〈 ∅ , init 〉 ⇓ {E}_{B} & t is fresh \\ 〈 ∅ , se 〉 ⇓ 〈 {E}^{′} , {r}^{′} 〉 & {E}^{( 2 )} = {E}_{B} [ t ↦ {r}^{′} ] \\ 〈 {E}^{( 2 )} , iter [ {c}_{1} , … in t ] ( ) \{ clist \} 〉 ⇓ 〈 {E}^{( 3 )} , r 〉 & \end{matrix}}{〈 E , iter [ {c}_{1} … in se ] ( init ) \{ clist \} 〉 ⇓ 〈 ∅ , r 〉} ITR$
$\frac{E ( s ) = [ ]}{〈 E , iter [ {c}_{1} … in s ] ( ) \{ clist \} 〉 ⇓ 〈 ∅ , [ ] 〉}$
$\frac{\begin{matrix}E ( s ) = {w}_{1} :: {w}^{′} & t is fresh \\ {E}_{c} = E [ {c}_{1} ↦ E ( s ) ( 1 ) ] … & 〈 {E}_{c} , clist 〉 ⇓ 〈 {E}^{( 2 )} , r 〉 \\ 〈 {E}^{( 2 )} [ t ↦ {w}^{′} ] , iter [ {c}_{1} , … in t ] ( ) \{ clist \} 〉 ⇓ 〈 {E}^{′} , {r}^{′} 〉 & \end{matrix}}{〈 E , iter [ {c}_{1} … in s ] ( ) \{ clist \} 〉 ⇓ 〈 {E}^{′} , r \cdot {r}^{′} 〉}$
$\frac{〈 E , caseclist 〉 ⇓ 〈 {E}^{′} , r 〉}{〈 E , clist 〉 ⇓ 〈 {E}^{′} , r 〉} \frac{\begin{matrix}〈 E , case 〉 ⇓ Skip \\ 〈 E , clist 〉 ⇓ 〈 {E}^{′} , r 〉 kip\end{matrix}}{〈 E , clist 〉 ⇓ 〈 {E}^{′} , r 〉}$
$\frac{\begin{matrix}〈 E , be 〉 ⇓ & T \\ 〈 E , cst 〉 ⇓ & 〈 {E}^{′} , r 〉\end{matrix}}{〈 E , case ( be ) \{ cst \} 〉 ⇓ 〈 {E}^{′} , r 〉} \frac{〈 E , be 〉 ⇓ F}{〈 E , case ( be ) \{ cst \} 〉 ⇓ Skip}$

A Boolean state (declared using init in ITR) is available across iterations, but local to the iter block for which it is declared. For each iteration, only the body of the topmost matching case is evaluated (CASES). Case statements may update the boolean state, and yield zero or more characters (not shown). Table 2 provides operational semantics for the iter construct. An evaluation relation may be defined as:

[symbol]

⊂(context×strexpr)×(context×string)

where a contextE maps variables to values. The iter judgments update the environment to carry boolean state across iterations and to update the character binders for each iteration. Each iteration consumes the first character w₁ of the current remaining string. The case block conditions are checked in sequence and the first case to match is executed. If none of the case conditions match, an implicit case (not shown) that outputs the empty string and makes no change to the state may be assumed. E(s)(n) may be written for the nth character in the value of string variable s. If n≧len(E(s)), then E(s)(n)=$. A character symbol $ that is uncomparable to in-domain characters may be defined.

A well-formed derivation under these inference rules starts with the base case: [symbol] E,t [symbol] [symbol] [symbol] Ø, E(t) [symbol] , where E is assumed as the initial assignment to t. The out state is used only by the evaluation rules for iter. Judgments may be elided for the search operations from and upto and the concatenation-with-a-constant operations. They may be defined directly in terms of their input string, yielding only the corresponding output string. Note that, in opsem, state E′ produced by the evaluation of nested string expression se (ltr judgment) may be ignored. Empty mapping may be emitted. In other words, the execution of an iter block is free of external side-effects. It follows that all toplevel strexpr judgments are side-effect free.

4 Translation to Finite State Transducers

This section relates to the translation of Bek expressions to finite state transducers. For a given Bek expression P, M[[ P ]] may be written for the corresponding finite state transducer. This construction is used to show that Bek programs are reversible: given a Bek expression P and an output string y, the maximal set R={x|P(x)=y} can be computed, and R is regular for any such computation. In Section 4.1, transducer-related definitions are provided. Section 4.2 exhibits the high-level translation from Bek to finite state transducers. Finally, in Section 5, the definitions of Section 4.1 are extended to a formal encoding of symbolic finite state transducers. This allows for an implementation that integrates Bek-program-induced constraints directly with other constraints.

4.1 Definitions

An exemplary embodiment operates in the context of a fixed multi-sorted universe of values, where each sort σ is (corresponds to) a sub-universe. The basic sorts employed are the Boolean sort bool, with the values t and f, and the sort bvⁿ of n-bit-vectors, for n≧1. The sort tuple(σ₀, . . . ,σₙ₋₁) is also used, for n≧1, of n-tuples of elements of sorts σᵢ for i<n. The sorts may be associated with built-in (predefined) functions and built-in theories. For example, an exemplary embodiment employs a built-in Boolean function (predicate) <:bv⁷×bv⁷→bool that provides a strict total order of all 7-bit-vectors that matches with the standard lexicographic order of ASCII characters. For each n-tuple sort there is a constructor and a projection function πᵢ:tuple [symbol] σ₀, . . . , σₙ₋₁ [symbol] →σᵢ, for i<n, that projects the i'th element from an n-tuple.

For each sort σ, list [symbol] a [symbol] is the list sort with element sort σ. Lists may be algebraic data types. There is an empty list ε: list [symbol] a [symbol] and for all e:σand l: list [symbol] a [symbol] , [e|l]: list [symbol] a [symbol] . The accessors are hd: list [symbol] a [symbol] →σ and tl: list [symbol] a [symbol] →list [symbol] a [symbol] with their usual meaning. The convention that [a, b, c] stands for the list [a|[b|[c|ε]]] may be adopted and l₁·l₂ may be written for the concatenation of l₁ with l₂. When convenient, length-bounded lists may be used in the context of finite sets (such as the alphabet of an automaton).

Words may be represented by lists. Typically, characters have sort bvⁿ for some fixed n>0, e.g., if words represent strings of ASCII characters, in which case constant characters are written as ‘a’ assuming for example ASCII encoding. In general, however, characters may have compound sorts such as tuple [symbol] bv⁷, bv⁷, bool [symbol] , although finite, e.g., unbounded lists will not be considered as characters.

An exemplary embodiment relates to classical automata theory. The subject innovation relates to finite (state) transducers. A finite state transducer is a generalization of a Mealy machine that, in addition to its input and output symbols, has a symbol such as E denoting the empty word making it possible to omit characters in the input and output words. In one exemplary embodiment, the following formal definition of a finite state transducer set forth in Definition 1 is used. This definition may be referred to as the standard form of a finite state transducer.

Definition 1.

A Finite State Transducer A is defined as a six-tuple (Q, q⁰, F, Σ, F, δ), where Q is a finite set of states, q⁰∈Q is the initial state, F⊂Q is the set of final states, Σ is the input alphabet, Γ is the output alphabet, and δ is the transition function from Q×(Σ∪{ε}) to 2^{Q×(δÅ{ε})}.

A component of a finite state transducer A may be indicated by using A as a subscript. Instead of (q,b)∈δ_{A}(p,a), the more intuitive notation

$$p {{\to }^{a / b}}_{A} q$$

, or

$$p {\to }^{a / b} q$$

may be used when A is clear from the context. Given words v and w, let v·w be the concatenated word. Note that v·ε=ε·v=v.

Given

$${q}_{i} {{\to }^{{a}_{i} / {b}_{i}}}_{A} {q}_{i + 1}$$

for i<n,

$${q}_{0} {{\to }^{v / w}}_{A} {q}_{n}$$

may be written where v=a₀·a₁·. . . ·aₙ₋₁ and w=b₀·b₁·. . . ·bₙ₋₁. A induces the binary relation [[A]] ⊂Σ_{A}^{*}×Γ_{A}^{*} as follows for which infix notation is used

$$v [ [ A ] ] w {=}^{def} ∃ q ∈ {F}_{A} ( {q}_{A}^{0} {\to }^{v / w} q )$$

Given two binary relations R₁ and R₂, R₁∘R₂ may be written for the binary relation {(x,y)|∃z(R₁(x,z) [symbol] R₂(z,y))}. A useful composition of finite state transducers A and B is the join composition of A and B, that is a finite state transducer A∘B such that [[A∘B]]=[[A]]∘[[B]].

Definition 2.

Let A and B be finite state transducers. The join composition of A and B is the finite state transducer

$$A ∘ B {=}^{def} ( {Q}_{A} \times {Q}_{B} , ( {q}_{A}^{0} , {q}_{B}^{0} ) , {F}_{A} \times {F}_{B} , {Σ}_{A} , {Γ}_{B} , {δ}_{A ∘ B} )$$

where δ_{A∘B} is defined as follows

$$( p , q ) {{\to }^{a / c}}_{A ∘ B} ( {p}^{′} , {q}^{′} ) {=}^{def} \begin{matrix}∃ b ( b \neq ɛ p {{\to }^{a / b}}_{A} {p}^{′} q {{\to }^{b / c}}_{B} {q}^{′} ) \\ ( p {{\to }^{a / ɛ}}_{A} {p}^{′} c = ɛ q = {q}^{′} ) \\ ( q {{\to }^{ɛ / c}}_{B} {q}^{′} a = ɛ p = {p}^{′} )\end{matrix}$$

The first case (disjunct) in the definition of δ_{A∘B} means that some character b is output in state p of A while input in the state q of B, thus consuming b in the composed transition that inputs a and outputs c (note that a or c may be ε). The second case means that A outputs nothing while inputting a, thus B stays in the same state. The third case means that B inputs nothing while outputting c, thus A stays in the same state. The following property is well-known.

Proposition 1.

Let A and B be finite state transducers. Then [[A∘B]]=[[A]]∘[[B]].

Similar to parallel composition of finite automata, the join composition of finite state transducers can be done incrementally using depth first search, avoiding the introduction of states that cannot be reached from the initial state, called unreachable states. Moreover, all states in a finite state transducer from which no final state can be reached, called dead states, can be elmininated through backwards reachability. Both optimizations may significantly decrease the size of the resulting composite transducer while preserving equivalence in terms of the denoted relation.

4.2 Translating Bek Expressions

The evaluation order for exemplary Bek programs is that each string expression depends either on the input variable t or on another string expression. There are no side effects, with the exception of the boolean state available in the iter construct, and that that boolean state is limited in scope to the iter block in which it is defined. This informs an approach, such that the translation function M[[·]] is defined recursively, using the composition operator∘on transducers to model nested string expressions. This leads to a single M[[·]] for each type of strexpr. Table 3 shows a high-level definition in the translation.

TABLE 3
High-level definition of M [[ · ]], the translation of Bek expressions
to corresponding finite state transducers.

| | |
|---|---|
| M[[ t ]] = | Ident |
| M[[ strexpr · w ]] = | M[[ strexpr ]] ∘ (Ident · Const(w)) |
| M [[ w · strexpr ]] = | M[[ strexpr ]] ∘ (Const(w) · Ident) |
| M[[ (se)from(firstw) ⋄ n ]] = | M[[ se ]] ∘ FF(w, 0 ⋄ n) |
| M[[ (se)from(lastw) ⋄ n ]] = | M[[ se ]] ∘ FL(w, 0 ⋄ n) |
| M[[ (se)upto(firstw) ⋄ n ]] = | M[[ se ]] ∘ UF(w, 0 ⋄ n) |
| M[[ (se)upto(lastw) ⋄ n ]] = | M[[ se ]] ∘ UL(w, 0 ⋄ n) |
| M[[ iter[cs in se](init) {cl} ]] = | M[[ se ]] ∘ Iter(cs, init, cl) |

In Table 3, the functions FL, UF, UL are symmetric with FF. Slide, described herein, returns a sliding window representation of its input to accomodate multi-character search and replacement. The integers x, y, and z represent the width of the window, the relative position of the “needle” in the window, and the relative positioning of the desired output, respectively.

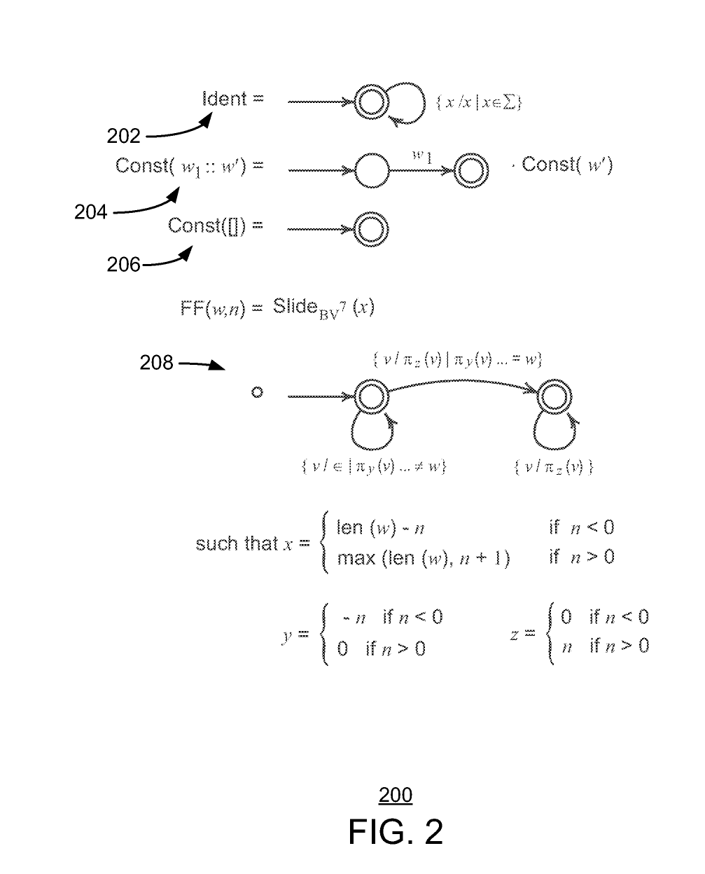

FIG. 2 is a diagram showing a plurality of finite state transducers 200 according to the subject innovation. The plurality of finite state transducers 200 includes an Ident transducer 202, a first Const transducer 204, a second Const transducer 206, and a Slide transducer 208.

The Slide function facilitates the translations for the first, upto, and iter constructs. For a given finite sort σ, Slide_{σ} takes an integer parameter and produces a transducer:

$$( Q , {q}^{0} , F , σ , tuple 〈 {\underbrace{σ ⋃ \{ \$ \} , … , σ ⋃ \{ \$ \}}}_{n} 〉 , δ )$$

so that any input of sort σ is split into partially overlapping n-tuples.

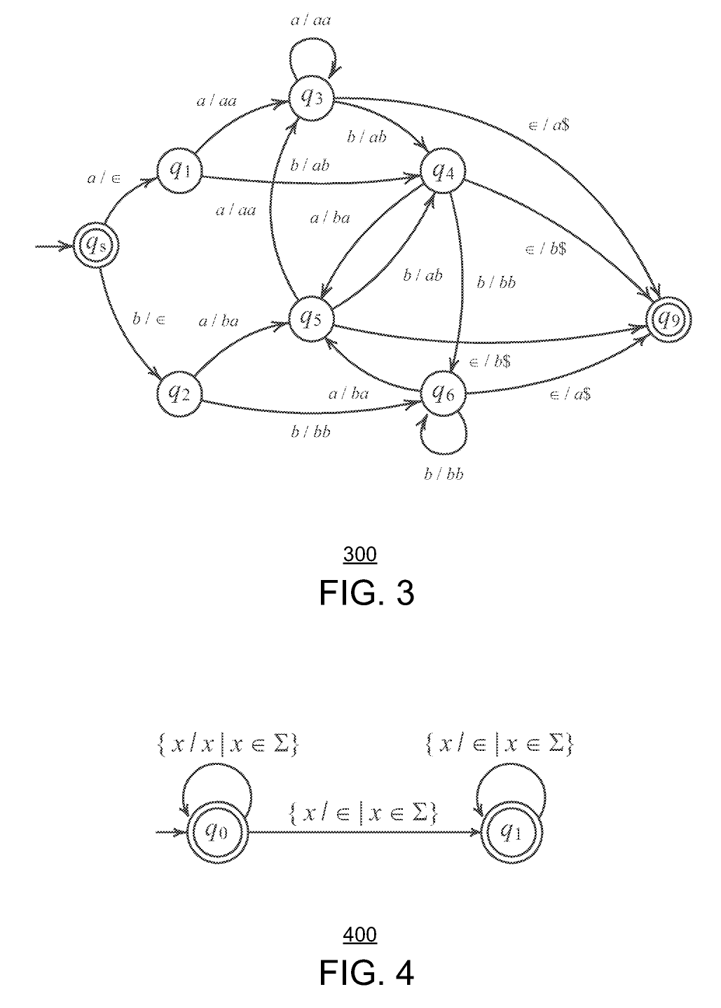

FIG. 3 is a state diagram 300 showing a finite state transducer for a slide function according to the subject innovation. For a length n and a finite sort σ, Slide_{σ}(n) transforms its input to an n-tuple output sort tuple [symbol] σ∪{$}, . . . , σ∪{$} [symbol] . The outputs represent a sliding window of the inputs. Note that these transducers grow very rapidly in the size of σ and n. It is discussed herein how to avoid concrete instantiation in Section 5. For clarity, the diagram elides edges from q₁ and q₂ to q₉.

### EXAMPLE 3

A toy example is considered below to illustrate how the Slide operation can be implemented using concrete transducers. slide shows the full transducer for Slide_{{a,b}}(2) (where {a,b} can be modeled using sort bv¹). Given an input sequence [abba], transducer output is

$$\begin{matrix}[ 〈 a , & b 〉 & & \\ & 〈 b , & b 〉 & \\ & & 〈 b , & a 〉 \\ & & 〈 & a , \$ 〉 ]\end{matrix}$$

Given a search request (t)from(firstb)−1 applied to this string, the first a can be outputted when the first pair [symbol] a, b [symbol] is seen. Searches that involve last are handled analogously, but there we rely on the nondeterminism of the transducer (i.e., once match is seen, it should not be seen again).

Intuitively, this conversion is used to provide look-ahead for the search operations first and upto, and to provide the sliding window for iter blocks. For the search operation translations (e.g., the definition of FF in thetranslation), implicit dedicated handling of the $ symbol may be assumed, so that that symbol never appears in the output of such an operation. Similarly, yield statements may be ignored if the character value is $. A symbolic representation is discussed in Section 5, in which state space does not grow eponentially.

The Iter function converts iter blocks into a corresponding finite state transducer. Table 4 describes a collecting semantics that defines this transducer:

TABLE 4
Semantics that define a transducer.
$\frac{\begin{matrix}F , P & ⊢ & {case}_{1} : {F}^{( 2 )} , {P}^{( 2 )} \\ {F}^{( 2 )} , {P}^{( 2 )} & ⊢ & {case}_{2} : {F}^{′} , {P}^{′}\end{matrix}}{F , P {case}_{1} {case}_{2} : {F}^{′} , {P}^{′}} CASES$
$\frac{\begin{matrix}{F}^{′} = F ⋃ \{ {q}_{{b}_{1}} {\to }^{bc \text{/} cc} {q}_{{b}_{2}} \text{\textbar} & bc = Red ( be ⋀ P ) ( {b}_{1} ) \\ & ⋀ cc = Yields ( cst ) ( bc ) \\ & ⋀ {b}_{2} = Symex ( cst ) ( bc ) \} \\ {P}^{′} = P ⋁ be & \end{matrix}}{F , P ⊢ case ( be ) \{ cst \} : {F}^{′} , {P}^{′}}$
$\frac{\begin{matrix}{F}^{( 2 )} = {Slide}_{{bv}^{7}} ( len ( cs ) \\ • ( Q , {q}_{Red ( init )} , Q , {bv}^{7} , {bv}^{7} , δ ) \\ {P}^{′} = false \\ {F}^{( 2 )} , {P}^{′} ⊢ cases : {F}^{′} , P \\ F = UnList ( {F}^{′} )\end{matrix}}{⊢ Iter ( cs , init , cases ) = F} {I}_{TR}$

The boolean states of the Bek expression may be represented using transducer states. q_{b} may be written for the states in which boolean expression b is satisfiable. Re d(b)(b′) may be written for the partial application of b as an open propositional term to b. Yields produces a list sort of character constraints. Symex processes case statements and converts them to an open propositional term.

A judgment of the following form may be introduced:

F,P├expr:F′,P′

which states that, given an initial transducer F and a possibly-open boolean term P, the given expression expr yields the updated transducer F′ and new term P′. The Itr judgment relates the collecting semantics to the output of the function Iter. To construct the transducer, the following process may be employed. A starting point is an initial transducer that has one state for each possible boolean assignment in the Bek expression (e.g., 2⁴ states if init declares four distinct variables). A mapping from concrete boolean states b to transducer states q_{b} may be assumed. The start state of the transducer is the state a_{b} such that b=Red(init), where Red reduces boolean Bek expressions to possibly-open propositional terms. This automaton may be composed on the left with a Slide transducer to produce a sliding window of the appropriate width.

According to an exemplary embodiment, case blocks may be processed in syntactic order (Cases). Recall that the semantics for case blocks require executing the first matching case (exclusively). F∪G may be written to denote the transducer F extended with the set of transitions G. P may be used to hold the disjunction of the case conditions already seen, and for each following case, disjunction may be required to be false.

Edges to be added in terms of logical conditions may be defined. In particalar, for the current case block, edges

$${q}_{{b}_{1}} {\to }^{bc / cc} {q}_{{b}_{2}}$$

for each q_{b}_{₁} are added given the following constraints:
1. be defines a feasible character condition. In other words, there exists at least one character so that, starting at in boolean state b₁, the case condition be is true.
2. cc corresponds to the list of yields in the current case. Each cᵢ in the character binder is replaced with the appropriate projection πᵢ(v), where v refers to the current input vector. Yield may be written to indicate the extraction of list constraints from the case body.
3. b₂ is the result of executing the boolean assignments in the current case, given initial boolean state b₁ and the case condition be. Symex may be written for the conversion of a sequence of boolean assignments to an open propositional term.

Finally, having added the appropriate edges for each case block, the output alphabet can be converted from Yield's list sort back to individual characters. Note that the maximum length of these lists is bounded by the maximum number of yield statements per case. The UnList operation is similar to Slide (e.g., slide). As with Slide, instantiating the UnList transducers directly is avoided, instead relying on axiomatic definition in the theorem prover.

In the following section, the notion of symbolic finite state transducers is described. This concept yields several direct benefits. First, instantiating prohibitively large transducers like those for Slide and UnList may be avoided by using dedicated axioms instead. Second, the symbolic encoding allows the use of the logical definition of iter directly without much further work.

5 Symbolic Finite State Transducers

This section describes the development of a theory of symbolic finite state transducers. The theory lends itself to efficient symbolic analysis using satisfiability modulo theories (SMT) solvers, and can be integrated through E-matching with other theories supported by such solvers.

First, a mathematical theory of symbolic finite state transducers is developed and proved to be well-defined for the class of well-founded finite state transducers. The theory employs a combination of the theory of algebraic data types, in particular lists, with the theory of uninterpreted function symbols that builds on the notion of model expansion from model theory. There follows a discussion of how algorithms can be built on top of the symbolic representation of finite state transducers with a particular emphasis on symbolic join composition that is used in the translation of Bek to finite state transducers, as discussed herein.

The theory developed herein is mapped to a background theory of an SMT solver in terms of universally quantified transducer axioms. The general working of such algorithms is discussed, as is an exemplary implementation using an SMT solver.

5.1 Symbolic Finite State Transducer Theory

In the following, let A=(Q,q⁰,F,Σ, Γ, δ) be a fixed finite state transducer. It may be assumed that all input characters have the same sort sort(Σ) and all output characters have the same sort sort(σ). The following definitions may be used to combine input/output pairs of characters between any fixed pair (p,q) of states in Q. These definitions facilitate a symbolic representation of transitions, as well as the defintion of the theory of A that is introduced below. Let δ^{(p,}^{_{—}}^{,}^{_{—}}^{,q)}(x,y), δ^{(p,ε,}^{_{—}}^{,q)}(y), δ^{(p,}^{_{—}}^{,ε,q)}(x), δ^{(p,ε,ε,q)} be predicates, where x: sort (Σ) and y: sort(σ) are free variables, such that, where Σ and σ are viewed as unary predicates:

$${δ}^{( p {,}_{{,}_{, q}} )} ( a , b ) ⇔ Σ ( a ) Γ ( b ) p {\to }^{a / b} q$$

$${δ}^{( p {,}_{, ɛ} , q )} ( a ) ⇔ Σ ( a ) p {\to }^{a / ɛ} q$$

$${δ}^{( p , ɛ {,}_{, q} )} ( b ) ⇔ Γ ( b ) p {\to }^{ɛ / b} q$$

$${δ}^{( p , ɛ , ɛ , q )} ⇔ p {\to }^{ɛ / ɛ} q$$

Note that the predicates can always be represented as explicit disjunctions by combining individual characters, but this would often defeat the purpose of getting a more succinct and more efficient representation for analysis by using built-in functions and implicit symbolic representations.

Definition 3.

A is said to be symbolic if δ is represented by predicates of the above form.

FIG. 4 is a block diagram showing a finite state transducer 400 realizing a prefix operation of words in Σ* where Σ=σ according to the subject innovation. The finite state transducer 400 is employed in the following Example 4.

### EXAMPLE 4

Consider the finite state transducer 400 shown in FIG. 4. The predicate δ^{(q}^{₀}^{,}^{_{—}}^{,}^{_{—}}^{,q}^{₀}⁾(x,y) can be defined as x=y. Both δ^{(q}^{₀}^{,}^{_{—}}^{,ε, q}^{₁}⁾(x) and δ^{(q}^{₁}^{,}^{_{—}}^{,ε,q}^{₁}⁾(x) can be defined as t.

An exemplary embodiment may adapt a notion of IDs and step relations to finite state transducers. As used herein, an ID refers to an Instantaneous Description of a possible state of a finite state transducer together with an input word and output word starting from that state. The formal definition is as follows.

Definition 4.

An ID of A is a triple (v, q, w) where v∈Σ*, q∈Q, and w∈σ*. The step relation of A is the binary relation_{A} over IDs induced by δ.

([a|v],p,[b|w])├_{A}(v,q,w) [symbol] δ^{(p,}^{_{—}}^{,}^{_{—}}^{,q)}(a,b)

([a|v],p,w)├_{A}(v,q,w) [symbol] δ^{(p,}^{_{—}}^{,ε,q)}(a)

(v,p,[b|w])├_{A}(v,q,w) [symbol] δ^{(p,ε,}^{_{—}}^{,q)}(b)

(v,p,w)├_{A}(v,q,w) [symbol] δ^{(p,ε,ε,q)}

The following proposition is an immediate consequence of the definitions.

Proposition 2.

v[A]w [symbol] ∃q∈F((v,q⁰,w)├_{A}^{*}(ε,q,ε)).

The overall idea behind the theory Th(A) introduced next is to precisely characterize [[A]]. The definition provides an axiomatic formalization of ├_{A}.

Definition 5.

Let A be as above. For each p∈Q, let

Accₚ: list [symbol] sort(Σ) [symbol] ×list [symbol] sort(Γ) [symbol] →bool

be a predicate symbol of Th(A) called the acceptor for p. Th(A) contains the following axiom for each Accₚ:

$${Acc}_{p} ( v \text{:} list 〈 sort ( Σ ) 〉 , w \text{:} list 〈 sort ( Γ ) 〉 ) ⇔ ( v = ɛ w = ɛ p ∈ F ) {}_{q ∈ Q} ( ( v \neq ɛ w \neq ɛ {δ}^{( p , \_ , \_ , q )} ( hd ( v ) , hd ( w ) ) {Acc}_{q} ( tl ( v ) , tl ( w ) ) ) ( v \neq ɛ {δ}^{( p , \_ , ɛ , q )} ( hd ( v ) ) {Acc}_{q} ( tl ( v ) , w ) ) ( w \neq ɛ {δ}^{( p , ɛ , \_ , q )} ( hd ( w ) ) {Acc}_{q} ( v , tl ( w ) ) ) ( {δ}^{( p , ɛ , ɛ , q )} {Acc}_{q} ( v , w ) ) )$$

The acceptor for A, denoted by Acc_{A}, is the acceptor for q⁰.

Note that the acceptor axioms above are written in a very general form and have not been simplifed. False disjuncts can simply be eliminated, e.g., when p∉F, or when there is no transition from p to q of a certain kind, as illustrated in the following example. The example also illustrates another simplification that can be used to eliminate some reqursive cases.

### EXAMPLE 5

Consider the transducer, say Prefix, in FIG. 3. Assume that both the input and the output alphabets contain all characters of sort sort(Σ) (e.g. bv⁷). Then Th(Prefix) contains the following two axioms.

Acc_{q}_{₀} [symbol] (v,w) [symbol] (v=ε [symbol] w=ε)V,

(v≠ε [symbol] w≠ε [symbol] hd(v)=hd(w)

[symbol]

Acc_{q}_{₀}(tl(v),tl(w)))V

(v≠ε [symbol] Acc_{q}_{₁}(tl(v),w))

Acc_{q}_{₁} [symbol] (v,w) [symbol] (v=ε [symbol] w=ε)V

(v≠ε [symbol] Acc_{q}_{₁}(tl(v),w))

The second axiom is equivalent to Acc_{q}_{₁}(v,w) [symbol] w=ε.

The final simplification in Example 5, say sink-simplification, can consistently be applied to acceptor axioms for final states q when Σ contains the eitirety of characters of sort(Σ), δ(q,x)={(q,ε)} for all x∈Σ and δ(q,ε)=, in which case

Acc_{q}(v,w) [symbol] w=ε

Thus, any input v:list [symbol] sort(E) [symbol] is accepted, i.e., the input characters do not have to be individually restricted to Σ since this is imposed by the sort, while the output is to be the empty word (list). Symmetrical simplification rule can be applied for output sink states.

For satisfiablity of formula φ (modulo the built-in theories), sat(φ) may be written. In other words, sat(φ) may be used to mean that there exists a model M that provides an interpretation for all the uninterpreted function symbols in φ such that Mφ. Note that the uninterpreted function symbols in Th(A) are the acceptors. Also, given a theory T, [symbol] T may be written for [symbol] _{φ∈T}φ.

The correctness criterion that for Th(A) to fulfill is sat( [symbol] Th(A) [symbol] Acc_{A}(v,w)) if and only if v[[A]]w. To this end, finite state transducers are considered whose step relation is well-founded.

Theorem 1.

If ├_{A} is well-founded then v[[A]]w if and only if sat ( [symbol] Th(A) [symbol] Acc_{A(v,w)).}

Proof.

Assume ├_{A} is well-founded. Thus, since Q is finite, there exists a well-ordering [symbol] _{Q} over Q such that

p [symbol] _{Q}q [symbol] [symbol] ((ε,q,ε)_{A}⁺(ε,p,ε)).

Define the lexicographic order >over Σ* ×Γ*×Q as:

$$( v , w , q ) ≻ ( {v}^{′} , {w}^{′} , {q}^{′} ) {=}^{def} \vert v \vert > \vert {v}^{′} \vert \\ ( \vert v \vert = \vert {v}^{′} \vert \vert w \vert > \vert {w}^{′} \vert ) \\ ( \vert v \vert = \vert {v}^{′} \vert \vert w \vert > \vert {w}^{′} \vert q {≻}_{Q} {q}^{′} )$$

The following statement follows by induction over [symbol] using Definition 5. For all p∈Q, v∈Σ*, and w∈Γ*:

∃_{q}∈F((v,p,w)├_{A}ⁱ(ε,q,ε)) [symbol] sat( [symbol] Th(A) [symbol] Accₚ(v,w))

Finally, let p=q⁰ and use Proposition 2.

The following proposition provides a useful condition over the structure of A that is equivalent to H _{A being well-founded; the proposition reflects the role of} [symbol] _{Q in the proof of Theorem} 1. An ε-loop is a non-empty path of ε-moves

$$p {\to }^{ɛ / ɛ} q$$

that starts and ends in the same state.

Proposition 3.

├_{A} is well-founded [symbol] A is ε-loop-free.

The practical significance of the proposition is that there is an efficient algorithm that given A in symbolic form constructs an equivalent E-loop-free finite state transducer from A in symolic form (provided that disjunction over predicates is supported efficiently).

While full ε-move elimination may cause quadratic increase in the number of symbolic transitions (by eliminating sharing), ε-loop elimination does not increase the number of symbolic transitions. For symbolic analysis, full ε-move elimination may reduce the performance considerably, similar to the case of symbolic finite automata.

The following definition provides an underpinning of the ε-loop elimination algorithm. Recall the definition of ε-closure, denoted here by ε(q), as the closure of {q}, for q├Q, by ε-moves (where stated for finite automata, but is similar for finite state transducers). Similarly, define ∃(q) as the closure of {q} by E-moves in reverse. Let

$$\tilde{q} {=}^{def} ɛ ( q ) ⋂ ∋ ( q )$$

(note that {q} ⊂\tilde{q}) and lift the notion to sets:

$$\tilde{P} {=}^{def} \{ \tilde{p} \vert p ∈ P \} .$$

Definition 6

Let

$$\tilde{A} {=}^{def} ( \tilde{Q} , , \tilde{F} , Σ , Γ , \tilde{δ} )$$

where

$${\tilde{δ}}^{( \tilde{p} , \_ , \_ , \tilde{q} )} {=}^{def} {}_{p ∈ \tilde{p} , q ∈ \tilde{q}} {δ}^{( p , \_ , \_ , q )}$$

$${\tilde{δ}}^{( \tilde{p} , \_ , ɛ , \tilde{q} )} {=}^{def} {}_{p ∈ \tilde{p} , q ∈ \tilde{q}} {δ}^{( p , \_ , ɛ , q )}$$

$${\tilde{δ}}^{( \tilde{p} , ɛ , \_ , \tilde{q} )} {=}^{def} {}_{p ∈ \tilde{p} , q ∈ \tilde{q}} {δ}^{( p , ɛ , \_ , q )}$$

$${\tilde{δ}}^{( \tilde{p} , ɛ , ɛ , \tilde{q} )} {=}^{def} {}_{p ∈ \tilde{p} , q ∈ \tilde{q} , \tilde{p} \neq \tilde{q}} {δ}^{( p , ɛ , ɛ , q )}$$

Note that if A is already ε-loop-free (such as the transducer 400 in FIG. 4) then A and Ã are isomorphic. The algorithm for constructing Ã can be implemented as a graph algorithm that collapses E-loops into single nodes and joins the labels with disjunction. The algorithm is linear in the number of nodes plus edges (symbolic transitions), which may be an order of magnitude smaller than the number of concrete transitions. The actual complexity depends on the complexity of computing disjunctions (that is, without simplifications, an O(1) operation in most SMT solvers).

The following theorem follows from Definition 6 and by using techniques similar to the proof of equivalence between nondeterministic finite automata and nondeterministic finite automata with epsilon-moves.

Theorem 2.

Ã is E-loop-free and [[A]]=[ [Ã]] .

Theorem 1 fails if the condition that ├_{A} is well-founded is omitted, as shown by the following example.

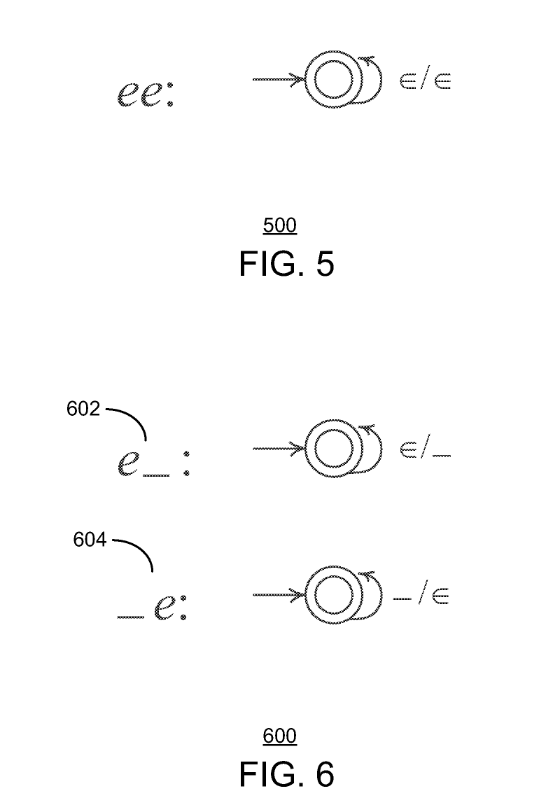

FIG. 5 is a diagram showing a transducer ee 500 according to the subject innovation.

### EXAMPLE 6

Consider the transducer ee 500 shown in FIG. 5. Thus, [[ee]]={(ε,ε)}and Th(ee) is

{Accₑₑ(v,w) [symbol] (v=ε [symbol] w=ε)VAccₑₑ(v,w)}.

For example, let M be a model such that M [symbol] Accₑₑ(v,w) for all v and w, then M [symbol] Th(ee), but v[[A]]w does not hold for all v and w.

The following theorem follows from Theorem 1, Proposition 3, and Theorem 2, and outlines the algorithm in a nut-shell for creating a soft-theory plug-in for A for an SMT solver.

Theorem 3.

v[[A]]w [symbol] sat( [symbol] Th(Ã) [symbol] Acc_{Ã}(v,w))

When asserting Th(Ã) as a soft theory to an SMT solver, the first assumption is that the solver actually supports lists as a built-in algebraic data type, which, unlike the acceptors, cannot be defined through uninterpreted functions, since the theory of algebraic data types is not first-order definable. Note that the proof of Theorem 1 would fail without this assumption, where [symbol] is defined in terms of lengths of words, which is well-defined since the notion of counting the elements of a list is well-defined.

5.2 Symbolic Finite State Transducer Algorithms

The built-in theory integration of SMT solvers can be exploited for directly encoding finite state transducer algorithms symbolically. One particular algorithm that may be used is a join composition of finite state transducers. The following propostion shows a direct encoding of join composition.

Proposition 4.

Assume sort(Γ_{A})=sort (Σ_{B}). Then sat ( [symbol] Th(Ã)∪Th(\tilde{B}) [symbol] ∃z(Acc_{Ã}(v,z) [symbol] Acc_{\tilde{B}}(z,w))) if and only if v[[A∘B]]w.

Proof.

The following statements are equivalent:

1. sat( [symbol] Th(Ã)∪Th(\tilde{B}) [symbol] ∃z(Acc_{Ã}(v,z) [symbol] Acc_{\tilde{B}}(z,w)))
2. ∃z s.t. sat( [symbol] Th(Ã) [symbol] Acc_{Ã}(v,z)) and sat( [symbol] Th(\tilde{B}) [symbol] Acc_{\tilde{B}}(z,w))

### 3. ∃z s.t. v[[A]]z and z[[B]]w.

The equivalence between 1 and 2 holds by disjointness of the uninterpreted function symbols (acceptors) of the theories. The equivalenve between item 2 and item 3 follows from Theorem 3. Finally, use Proposition 1.

While absence of E-moves is preserved for example by parallel composition of finite automata, this is not the case for join composition of finite state transducers.

FIG. 6 is a diagram showing a plurality of transducers 600 according to the subject innovation. The plurality of transducers 600 comprises a transducer e_ 602 and a transducer _e 604.

### EXAMPLE 7

Consider the transducer e_ 602 and the transducer _e 604 that have no ε-moves, and where the input and output aphabets are, say bool. Then e_∘_e=ee with ee as in Example 6. It is therefore interesting to note that Th(e_)∪Th(_e) is well-defined by Proposition 4. Note that, with sink-simplification, as explained after Example 5, the axioms for Th(e_{—) and Th(}_e) are Accₑ_{_{—}}(_, w) [symbol] w=ε and Acc_{_{—}}ₑ(v,_) [symbol] v=ε, respectively.

In general, acceptors can be taken for regular and context free languages. They may be combined with finite state transducer acceptors and SMT may be used to solve them. For example, suppose L is a regular language with a theory Th(L) defining the acceptor Acc_{L} such that Acc_{L}(v)iff v∈L, and A is a finite state transducer then {w|∃v(Acc_{L}(v) [symbol] Acc_{A}(v,w))} is the relational image of L under A.

While such direct encodings have certain advantages, such as generality, they cannot easily cope with unsatisfiable solutions when the acceptors are recursive and accept infinite languages. For example, a symbolic join composition algorithm that first constructs A∘B may discover that A∘B is empty, while the direct use of Th(A)∪Th(B) does not terminate. There are many non-intuitive algorithmic tradeoffs that arise with the symbolic algorithms for finite state transducers, similar to the case with finite automata.

5.3 Implementation with SMT solvers

The general idea behind the encoding of Th(A) of a well-founded finite state transucer A as a theory of an SMT solver, is similar to the encoding of language acceptors. Particular kinds of axioms are used, all of which are equations of the form

∀ x̅(tₗₕₛ [symbol] tᵣₕₛ) (1)

where FV(tₗₕₛ)= x̅ and FV(tᵣₕₛ)⊂ x̅. The left-hand-side tₗₕₛ of ((1)) is called the head of ((1)) and the right-hand-side tᵣₕₛ of ((1)) is called the body of ((1)). While SMT solvers support various kinds of patterns in general for triggering axioms, here it is assumed that the pattern of an equational axiom is always its head. The acceptor symbols are declared to the SMT solver as uninterpreted Boolean function symbols with the given sorts. In an exemplary encoding of Th(A), each acceptor axiom in Th(A) is represented by two axioms, one for the case Accₚ(ε, w) and one for the case Accₚ([x|v], w), motivated by an application domain where proofs are triggered by input words.

Such axioms are asserted as equations that are expanded during proof search. Expanding the formula up front is problematic since the equational axioms are in general mutually recursive and a naive a priori exhaustive expansion would in most cases not terminate, while straight-forward depth-bounded expansions are impractical as the size of the expansion is easily exponential in depth. Well-foundedness of A guarantees termination of the expansion process during proof search.

An exemplary SMT solver has features that include the integrated combination of decision procedures for algebraic data-types, integer linear arithmetic, bit-vectors and quantifier instantiation. In addition, incremental features are used to allow manipulation of logical contexts while exploring different combinations of constraints. Working within a context enables incremental use of the solver. A context may include declarations for a set of symbols, assertions for a set of formulas, and the status of the last satisfiability check (if any). There may be a current context and a backtrack stack of previous contexts. Contexts can be saved through pushing and restored through popping. This feature may be used for implementing the satisfiability checks performed during symbolic join composition of finite state transducers.

6 Exemplary Implementation and Case Study

An exemplary implementation contains the basic transducer algorithms and SMT solver integration, as well as code for translation from Bek.

6.1 Sliding Window Axioms

When dealing with creating transducers from Bek, it may be desirable to maintain a sliding window of characters (providing a look-ahead in the input string) and to output multiple characters in an iter block. In some cases, efforts to accomplish these goals may lead to undesirably rapid growth of the transducer state space for general purpose Bek programs. For example, assuming a look-ahead of four characters in the output string and a relatively small alphabet size of 20 characters may result in a transducer with over 200,000 states.

A technique that enables scaling the approach on a collection of micro-benchmarks, includes using additional axioms and combining them with the acceptor axioms. In particular, when outputting a list of strings (that are represented as lists of bounded length), an axiom for folding such lists back to lists of singleton characters that are then fed to another transducer acceptor or an automaton acceptor may be used. For example, for upper bound three, the following axiom may be used:
fold(x: list [symbol] list [symbol] σ [symbol] [symbol] ,y: list(σ)) [symbol] (x=ε [symbol] y=ε)V
(x≠ε [symbol] hd(x)≠ε [symbol] tl(hd(x))=ε [symbol]
y≠ε [symbol] hd(hd(x))=hd(y) [symbol] fold(tl(x),tl(y)))V
hd(x)has exactly 2 characters case V
hd(x)has exactly 3 characters case
   E.g., fold ([[a, b], [c, d, e], [f]], [a, b, c, d, e, f]). Using axioms of this kind, several acceptors may be connected in a chain (avoiding the state space explosion), as in φ:

∃xyz(Acc_{A}(x,y) [symbol] fold(y,z) [symbol] Acc_{B}(z)),

where A is a transducer generated from a sanitizer, and B is an acceptor for a regex pattern of disallowed output strings. Then cp is satisfiable iff the sanitizer has a bug, i.e., when there exists an input x that may produce an unwanted output. Moreover, the actual model generation with an SMT solver yields concrete witnesses for the existential variables and if no model is found then the sanitizer is correct with respect to B.

6.2 Macrobenchmarks

A framework according to the subject innovation has been applied to the analysis of code from Web programs. A sanitization function in the Web context is “HTMLEncode,” which takes a string and “escapes” characters such as angle brackets. This sanitization function has been re-implemented multiple times for different Web programs and libraries. Nonetheless, all of these implementations do not necessarily compute the same function. If not, it may be desirable to know whether the set of characters escaped by one is a superset of the characters escaped by another. This information may be of interest because failing to escape some characters can directly lead to a cross-site scripting attack by an adversary who can use the unescaped character to change a web browser's behavior.

A number of implementations of the HTMLEncode function have been translated to the Bek language. According to the subject innovation, implementations of HTMLEncode are easily represented as a simple Bek iteration over single characters of the input string. In one example, each iteration had 256 cases, one for each potential character value. Metaprograms in Perl to output the C# constructor code has been used to create parse trees for Bek programs. Symbolic finite transducers may be extracted from existing code in other languages.

It has been shown that Bek is sufficiently expressive to handle a Web sanitizer and that the translation effort does not incur undue programmer time or overhead. Characters common in cross-site scripting attacks designed to foil sanitization have been the subject of evaluation. According to the subject innovation, it can be determined whether such characters can be legal outputs of a sanitizer simply by transforming its Bek program to a symbolic finite state transducer, asserting that the output of the transducer is equal to the character in question, and then using a framework as described herein to solve for an input that yields the character. Moreover, finite state transducers may be translated into other languages such as JavaScript and C#.

The single quote character has been determined to be a legal output of the System.Web HTMLEncode implementation. This could potentially result in security problems with the System.Web implementation, because the single quote character can be used in some HTML contexts to close string literals and open the way for a browser to treat subsequent strings as Javascript. Moreover, the System.Web implementation, which also happens to be a relatively difficult to understand C# implementation of HTMLEncode, does not transform single quotes under any circumstances. An exemplary embodiment was able to solve for an example input exhibiting the problem in less than a second.

An exemplary embodiment has also shown that there are no strings of any length that result in single quotes in a legal output from other evaluated sanitizer implementations. Evaluated implementations of HTMLEncode exhibited the property that they do not drop characters from the input on any path. Therefore, results of a framework according to the subject innovation are sufficient to show that no legal output of these sanitizers can contain single quotes.

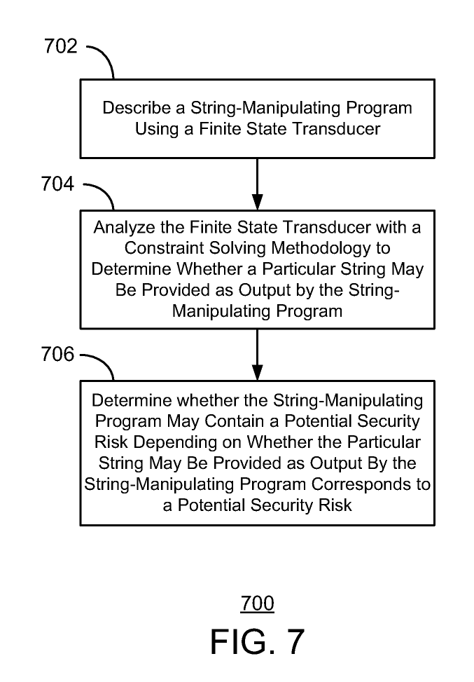

FIG. 7 is a process flow diagram of a method 700 for evaluating string-manipulating programs in accordance with the subject innovation. At block 702, a string-manipulating computer program is described using a finite state transducer, as described herein. The finite state transducer may comprise a symbolic finite state transducer, as described herein. Using a constraint solving methodology, the finite state transducer is analyzed to determine whether a particular string may be provided as a potential output of the string-manipulating program represented by the finite state transducer, as shown at block 704. The constraint solving methodology may entail the use of one or more SMT solvers, as set forth herein. At block 706, the analysis of the finite state transducer is used to make a determination regarding whether the particular string, if provided as output of the string-manipulating program, corresponds to a potential security risk. If the particular symbol does correspond to a security risk, a sanitization operation may be performed.

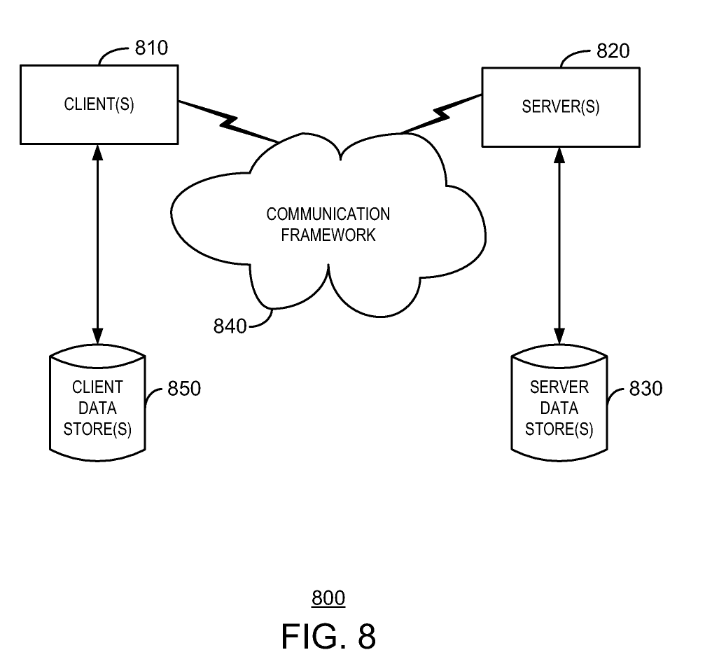

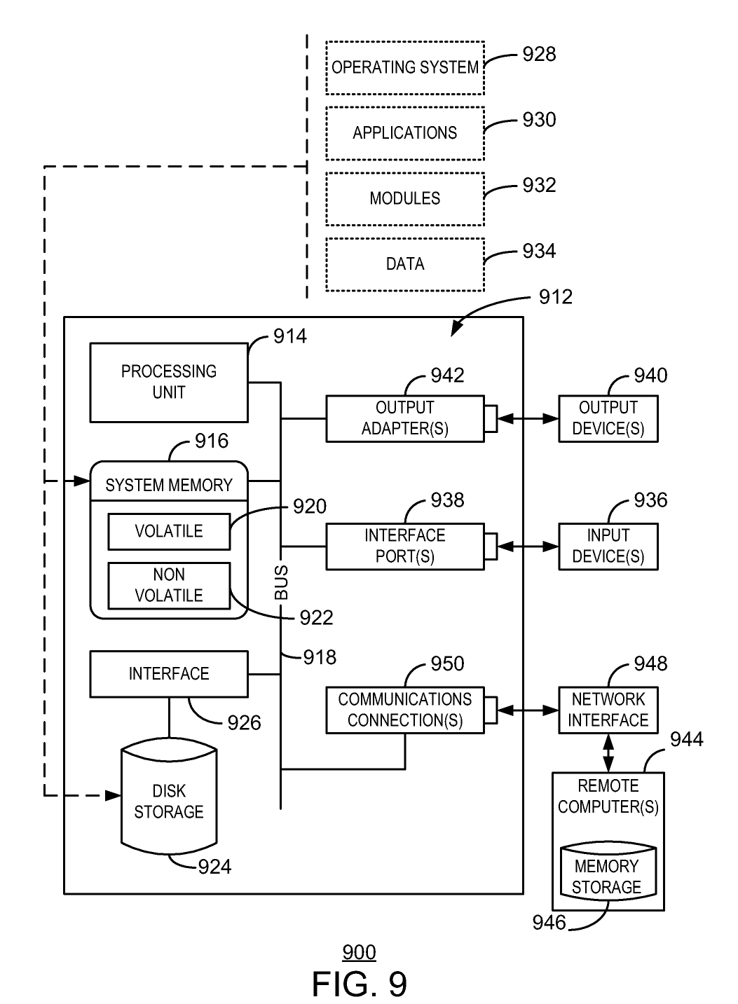

In order to provide additional context for implementing various aspects of the claimed subject matter, FIGS. 8-9 and the following discussion are intended to provide a brief, general description of a suitable computing environment in which the various aspects of the subject innovation may be implemented. For example, a system that identifies potential security vulnerabilities can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the subject innovation may be practiced with other computer system configurations, including single-processor or multi- processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 8 is a schematic block diagram of a sample-computing system 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform search operations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. The client data store(s) 850 may be stored in the client(s) 810, or, may be located remotely, such as in a cloud server. Similarly, the server(s) 820 are operably connected to one or more server data store(s) 830 that can be employed to store information local to the servers 820.

As an example, the client(s) 810 may be computers providing access to search engine sites over a communication framework 840, such as the Internet. Moreover, the server(s) 820 may host search engine sites accessed by the client.

With reference to FIG. 9, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures known to those of ordinary skill in the art.

The system memory 916 is non-transitory computer-readable media that includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory.

Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 912 also includes other non-transitory computer-readable media, such as removable/non-removable, volatile/non-volatile computer storage media. FIG. 9 shows, for example a disk storage 924. Disk storage 924 includes, but is not limited to, devices like a magnetic disk drive, floppy disk drive, tape drive, Jaz drive, Zip drive, LS-100 drive, flash memory card, or memory stick.

In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912.

System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 936 connect to the processing unit 914 through the system bus 918 via interface port(s) 938. Interface port(s) 938 include, for example, a serial port, a parallel port, a game port, and a universal serial bus (USB).

Output device(s) 940 use some of the same type of ports as input device(s) 936. Thus, for example, a USB port may be used to provide input to the computer 912, and to output information from computer 912 to an output device 940.

Output adapter 942 is provided to illustrate that there are some output devices 940 like monitors, speakers, and printers, among other output devices 940, which are accessible via adapters. The output adapters 942 include, by way of illustration and not limitation, video and sound cards that provide a means of connection between the output device 940 and the system bus 918. It can be noted that other devices and/or systems of devices provide both input and output capabilities such as remote computer(s) 944.

The computer 912 can be a server hosting a search engine site in a networked environment using logical connections to one or more remote computers, such as remote computer(s) 944. The remote computer(s) 944 may be client systems configured with web browsers, PC applications, mobile phone applications, and the like, to allow users to access the social networking site, as discussed herein. The remote computer(s) 944 can be a personal computer, a server, a router, a network PC, a workstation, a microprocessor based appliance, a mobile phone, a peer device or other common network node and the like, and typically includes many or all of the elements described relative to the computer 912. For purposes of brevity, a single memory storage device 946 is illustrated with remote computer(s) 944. Remote computer(s) 944 is logically connected to the computer 912 through a network interface 948 and then physically connected via a communication connection 950.

Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to the computer 912. The hardware/software for connection to the network interface 948 may include, for exemplary purposes only, internal and external technologies such as, mobile phone switches, modems including regular telephone grade modems, cable modems and DSL modems, ISDN adapters, and Ethernet cards.

An exemplary embodiment of the computer 912 may comprise a server hosting a search engine site. An exemplary processing unit 914 for the server may be a computing cluster comprising Intel® Xeon CPUs. The search engine may be configured to perform reformulation of search queries according to the subject innovation.

The subject innovation relates to a method of reformulating search queries in which expansion candidates are acquired by random walk on a graph that derived by aligning terms in document streams. The models described herein have relied on data derived from document streams and user behavior. Moreover, a model according to the subject innovation is extensible and affords a natural and relatively principled means of integrating heterogeneous data.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc. which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to merely one of several implementations, such a feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented method for analyzing string-manipulating programs, the method comprising:
describing a string-manipulating program using a finite state transducer;
analyzing the finite state transducer with a constraint solving methodology to determine whether a particular string may be provided as output by the string-manipulating program; and
determining whether the string-manipulating program may contain a potential security risk depending on whether the particular string may be provided as output by the string-manipulating program.

2. The computer-implemented method recited in claim 1, wherein the finite state transducer comprises a symbolic finite state transducer.

3. The computer-implemented method recited in claim 2, comprising optimizing the symbolic finite state transducer.

4. The computer-implemented method recited in claim 1, comprising representing the string-manipulating program using one or more satisfiability modulo theories (SMT) solvers.

5. The computer-implemented method recited in claim 1, comprising preventing the string-manipulating program from providing the particular string as output if the particular string corresponds to the potential security risk.

6. The computer-implemented method recited in claim 1, comprising determining an input to the finite state transducer that produces the particular output.

7. The computer-implemented method recited in claim 1, comprising defining the finite state transducer using a domain-specific programming language.

8. The computer-implemented method recited in claim 1, comprising translating the finite state transducer into another language.

9. The computer-implemented method recited in claim 1, wherein analyzing the finite state transducer comprises determining whether the finite state transducer is idempotent, determining whether the finite state transducer is reversible, determining whether the finite state transducer and another finite state transducer commute, determining if two finite state transducers are equivalent, determining if one finite state transducer is a subset of another, or determining a set of strings output by two transducers.

10. The computer-implemented method recited in claim 1, comprising extracting the finite state transducer from existing code in a different language.

11. The computer-implemented method recited in claim 1, wherein the potential security risk comprises cross-site scripting or SQL injection.

12. A system for identifying potential security risks, comprising:
a processing unit; and
a system memory, wherein the system memory comprises code configured to direct the processing unit to describe a string-manipulating program using a finite state transducer, to analyze the finite state transducer with a constraint solving methodology to determine whether a particular string may be provided as output by the string-manipulating program, and to determine whether the string- manipulating program may contain a potential security risk depending on whether the particular string may be provided as output by the string-manipulating program.

13. The system recited in claim 12, wherein the finite state transducer comprises a symbolic finite state transducer.

14. The system recited in claim 12, comprising representing the string-manipulating program using one or more satisfiability modulo theories (SMT) solvers.

15. The system recited in claim 12, wherein the system memory comprises code configured to direct the processing unit to prevent the computer program from providing the particular string if the particular string corresponds to the potential security risk.

16. The system recited in claim 12, wherein the system memory comprises code configured to direct the processing unit to determine an input to the finite state transducer that produces the particular output.

17. The system recited in claim 12, wherein the finite state transducer is defined with a domain-specific programming language.

18. The system recited in claim 12, wherein the potential security risk comprises cross-site scripting or SQL injection.

19. One or more computer-readable storage media, comprising code configured to direct a processing unit to describe a string-manipulating program using a finite state transducer, to analyze the finite state transducer with a constraint solving methodology to determine whether a particular string may be provided as output by the string-manipulating program, and to determine whether the string-manipulating program may contain a potential security risk depending on whether the particular string may be provided as output by the string-manipulating program.

20. The one or more computer-readable media recited in claim 19, wherein the finite state transducer comprises a symbolic finite state transducer.
